(19) United States
(12) Patent Application Publication
(10) Pub. No.: US 2007/0104333 A1
(43) Pub. Date: May 10, 2007

(54) Headset with built-in power supply

(76) Inventor: Bill Kuo, Chung He City (TW)

Correspondence Address: LEONG C LEI, PMB # 1008, 1867 YGNACIO VALLEY ROAD, WALNUT CREEK, CA, 94598, US

(21) Appl. No.: 11/268,541

(22) Filed: Nov. 8, 2005

(51) Int. Cl. H04R 1/10; H04R 25/00

(52) U.S. Cl. 381/74; 381/384

(57) ABSTRACT

A novel headset is provided herein which has a built-in power supply and combines the audio connection of the headset and the electrical connection of the power supply inside a single physical cable to an appliance. On the male plug of the cable for plugging the appliance's female jack, there are four ring connectors for the connection of the left audio channel, right audio channel, power supply, and a common ground for both the audio channels and the power supply, respectively.

### BACKGROUND OF THE INVENTION

(a) Technical Field of the Invention

The present invention generally relates to headsets and, more particularly, to a headset having a battery pack from which electricity is supplied to an appliance the headset is connected.

(b) Description of the Prior Art

As portable consumer electronic appliances are gaining widespread popularity, headsets have become an indispensable accessory. Traditionally, the design focus of a headset is about reducing the distortion to or enhancing the quality of the delivered voice or music.

On the other hand, as the market continues to demand the portable appliances to have an even smaller form factor and an even lighter weight, the power supply (usually a battery or batteries) built inside the portable appliances has become one of the greatest obstacles to overcome in downsizing the portable appliances. The appearance of the appliances is often designed around the built-in power supply which takes up most of the internal space of the appliances; otherwise, a custom made power supply is required which contributes to a higher product cost.

Therefore, an unconventional idea is proposed, instead of to put up with the built-in power supply, to relocate the power supply to somewhere outside the appliances.

### SUMMARY OF THE INVENTION

The primary purpose of the present invention is to provide a headset combined with the power supply to an appliance into a single device. Without the burden to accommodate a bulky built-in power supply, the appliance could be lighter, smaller, and more versatile in terms of its appearance.

To achieve the foregoing objective, a headset provided by the present invention has a built-in power supply and combines the audio connection of the headset and the electrical connection of the power supply inside a single physical cable to the appliance. The cable is just like an ordinary headset cable except that, on the male plug of the cable for plugging into the appliance's female jack, there are four ring connectors for the connection of the left audio channel, the right audio channel, the power supply, and the common ground for both the audio channels and the power supply, respectively. As long as the female jack is designed accordingly, the headset can not only receive audio signals from the appliance but also can act as an external power supply to the appliance simultaneously.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a headset according to an embodiment of the present invention.

FIG. 2 is a partially enlarged view showing a male plug of the headset according to an embodiment of the present invention.

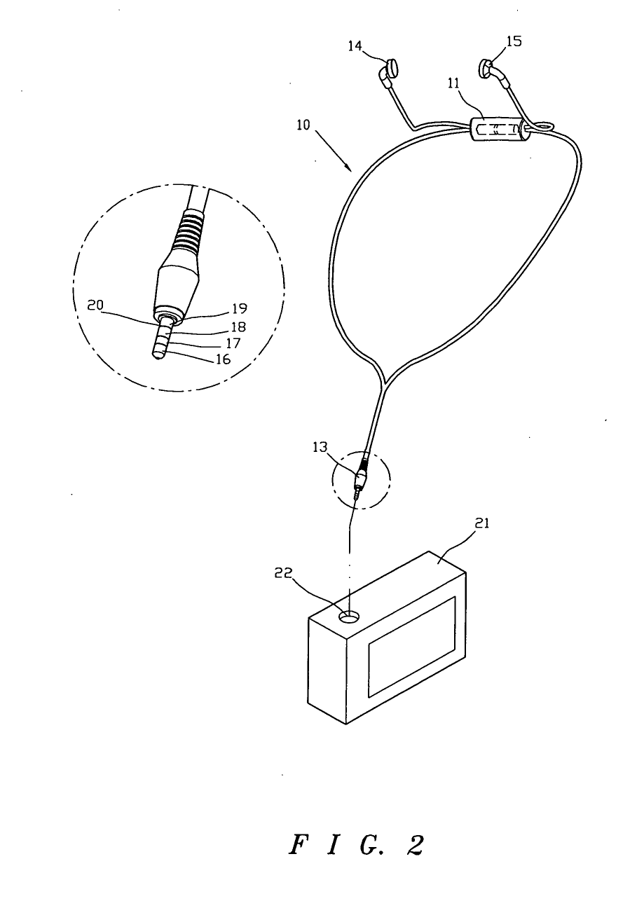

FIG. 3 is a schematic view showing the connection of the mail plug of FIG. 2 into a female jack of an appliance.

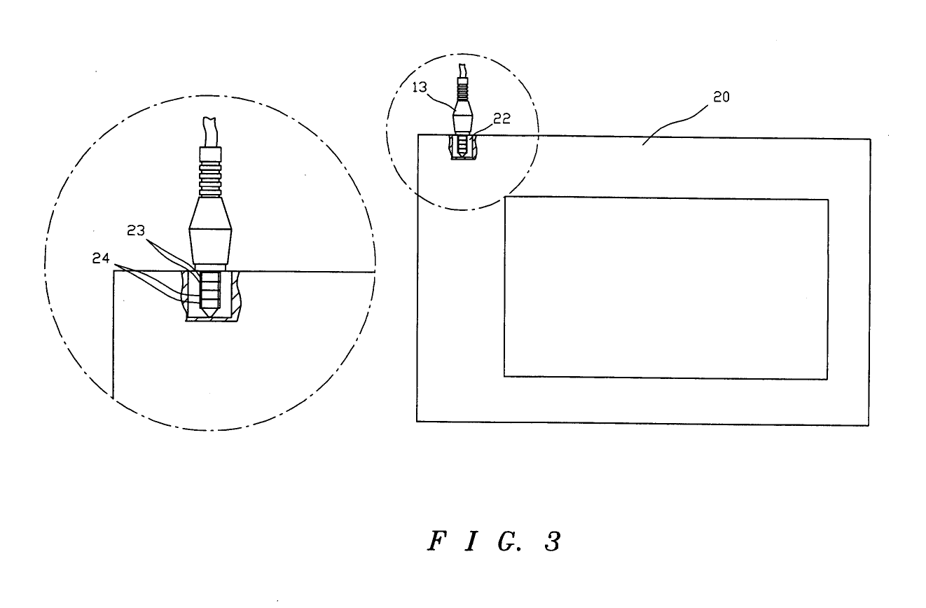

FIG. 4 is a partially enlarged view showing a battery pack of the headset according to a first embodiment of the present invention.

FIG. 5 is a partially enlarged view showing a battery pack of the headset according to a second embodiment of the present invention.

FIG. 6 is a partially enlarged view showing a battery pack of the headset according to a third embodiment of the present invention.

FIG. 7 is a partially enlarged view showing a battery pack of the headset according to a fourth embodiment of the present invention.

FIG. 8 is a partially enlarged-view showing a battery pack of the headset according to a fifth embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

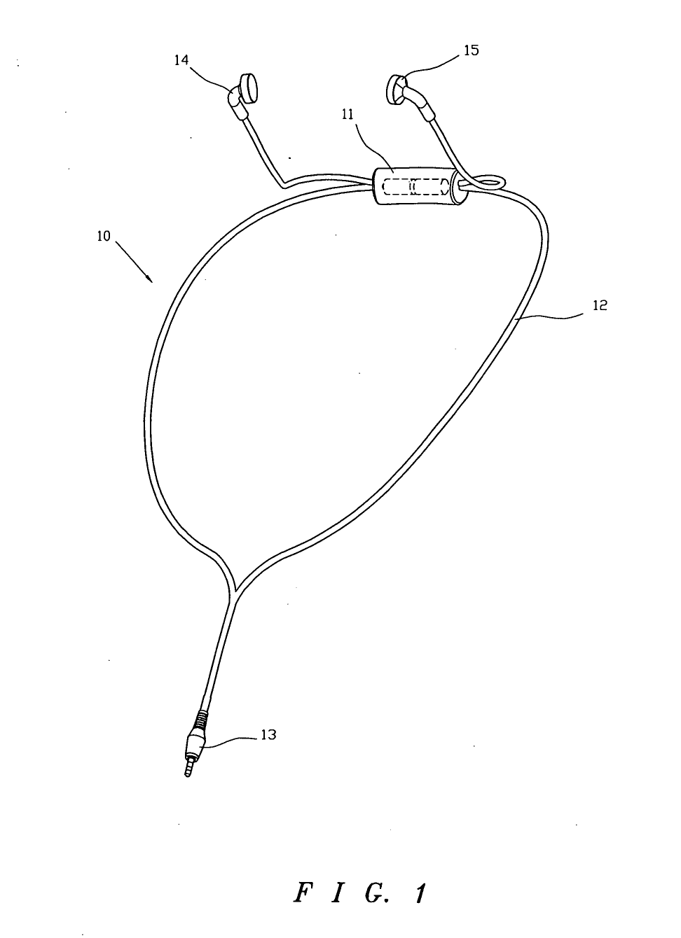

As shown in FIGS. 1˜3, a headset 10 according to an embodiment of the present invention has a battery pack 11 configured on a headset cable 12 which has a male plug 13 at one end. The male plug 13 has a metallic prong (not numbered) which is partitioned into four ring connectors by ring insulators 20 therebetween. The ring connectors 16 and 17 are for receiving audio signals from the left and right audio channels of an appliance 21, respectively. The ring connector 19 is the positive end of the battery pack 11 for delivering electricity to the appliance 21. The ring connector 18 is a common ground for both the audio channels and the battery pack. Please note that the positive end of the battery pack 11 is arranged at the ring connector 19 which is farthest away from the tip of the prong and is separated from the audio channels by the common ground at the ring connector 18 so as to avoid accidentally damaging the appliance 21 by the electricity of the battery pack 11 when the male plug 13 is plugged into a female jack 22 of the appliance 21. Please also note that the arrangement of the left and right audio channels on the male plug 13 could also be reversed in some embodiment.

Inside the female jack 22 of the appliance 21, there are power connectors 23 for receiving the electricity from the ring connectors 18 and 19, and there are audio output connectors 23 for delivering audio signals to the ring connectors 16 and 17. Therefore, when the male plug 13 is plugged into the female jack 22, the electricity from the battery pack 11 could drive the appliance 21, and the left- and right-channel audio signals produced by the appliance 21 could be delivered to the ear plugs 14 and 15 respectively via the ring connectors 16 and 17, and via the cable 12.

Please note that, in some alternative embodiment of the present invention, the male plug 13 could have five ring connectors, instead of four as in the previous embodiment, by having separate grounds for the audio channels and the power supply. As such, the connectors inside the female jack 22 should be modified accordingly.

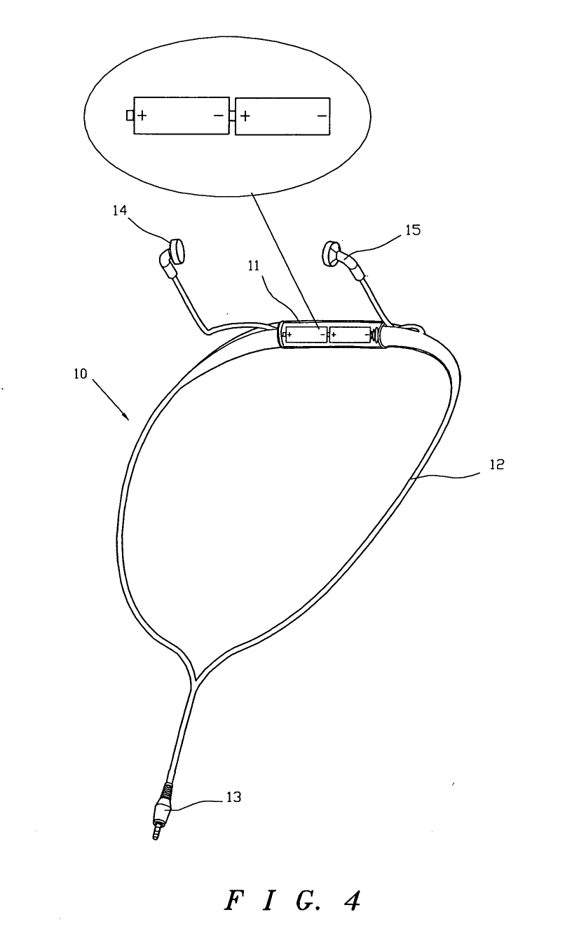

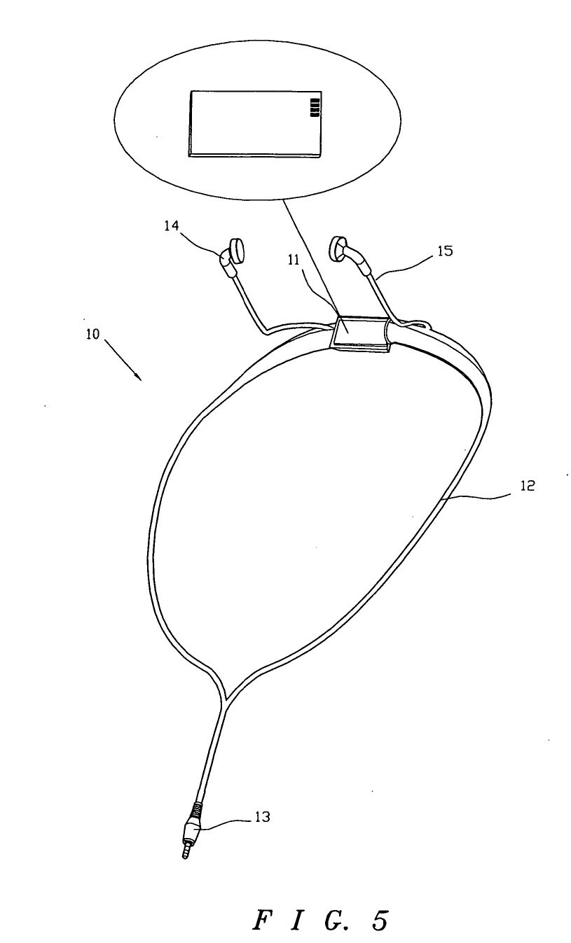

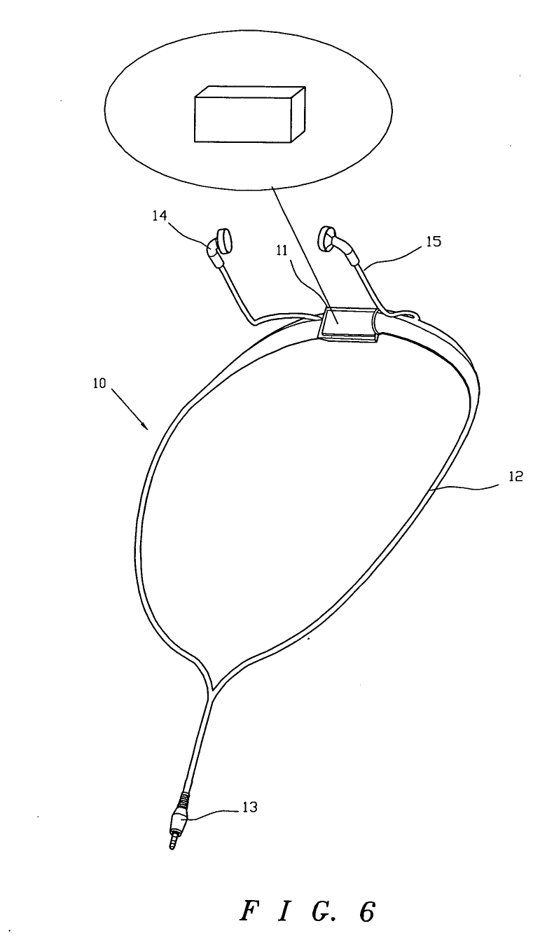

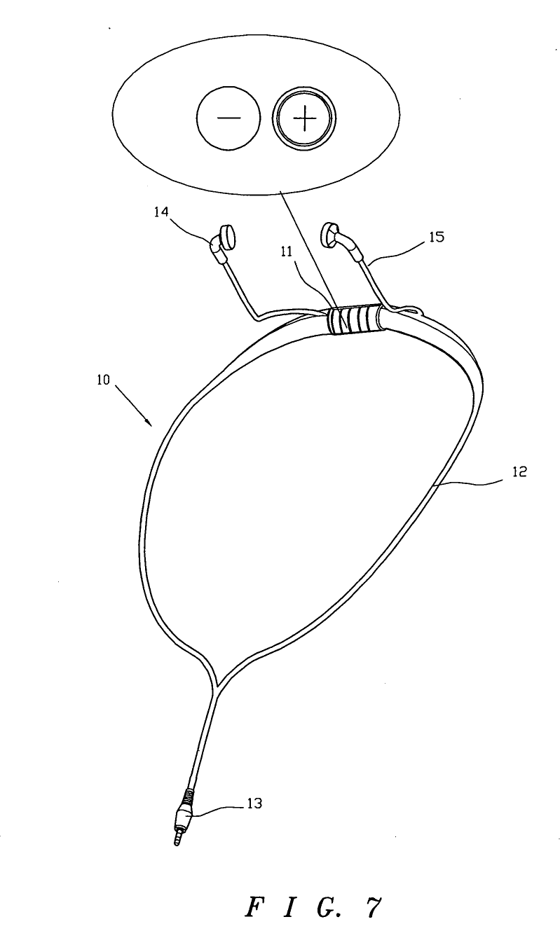

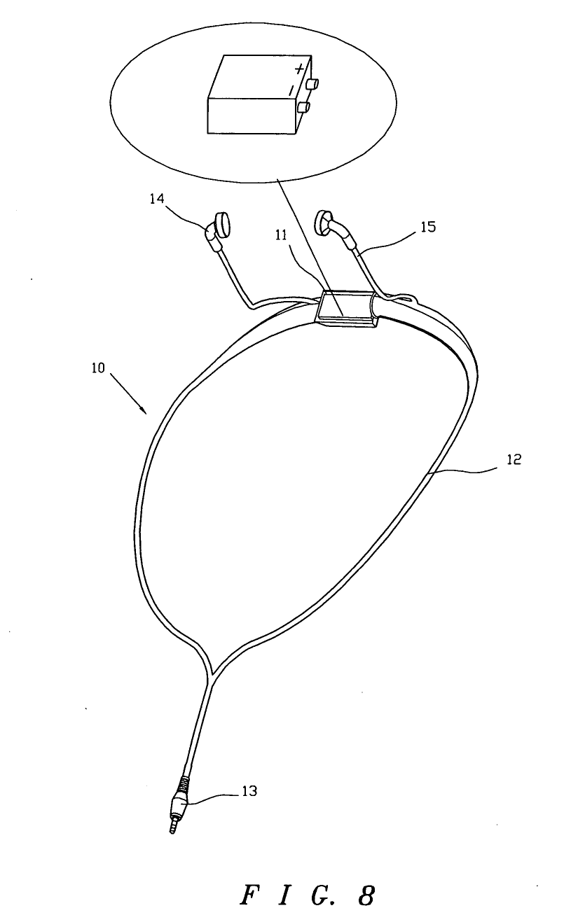

Depends on the power requirement of the appliance 21, the battery pack 11 could contain various types or numbers of batteries, and could have various types of housing and connection design based on the batteries used. For example, the battery pack 11 could contain two conventional AA or AAA type batteries as shown in FIG. 4, or a lithium-ion battery commonly found in cellular phones as shown in FIG. 5, or other lithium-ion battery as shown in FIG. 6, or a number of mercury or silver oxide batteries as shown in FIG. 7, or an alkaline battery as shown in FIG. 8.

There are also some embodiments whose battery pack 11 has a flexible clip for cling the battery pack 11 to a user's belt or pocket.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A headset having a built-in power supply configured on a headset cable of said headset, said headset cable having a male plug for plugging into a female jack of an appliance, said male plug having a plurality of ring connectors separated by ring insulators on a metallic prong of said male plug for receiving left and right channel audio signals and for providing electricity and grounds respectively, said female jack having corresponding connectors for delivering left and right audio signals produced by said appliance to and receiving electricity from said male plug to drive said appliance.

2. The headset according to claim 1, wherein said power supply is a battery pack accommodating at least a battery of an appropriate type.

3. The headset according to claim 1, wherein said power supply has a flexible clip for clinging said power supply to a user's belt or pocket.
